(19) United States
(12) Patent Application Publication
(10) Pub. No.: US 2004/0191286 A1
(43) Pub. Date: Sep. 30, 2004

(54) Head lice medication and treatment

(76) Inventor: Bijan Safai, New York, NY (US)

Correspondence Address: MORGAN LEWIS & BOCKIUS LLP, 1111 PENNSYLVANIA AVENUE NW, WASHINGTON, DC, 20004, US

(21) Appl. No.: 10/395,807

(22) Filed: Mar. 24, 2003

(51) Int. Cl. A01N 25/00

(52) U.S. Cl. 424/405

(57) ABSTRACT

The medication for head lice includes glue and a de-licing insecticide such as d-Limonene or highly concentrated lemon juice. The glue is effective because application of the glue, in a soft or liquid state, to the hair and scalp results in the lice becoming entrapped in the glue. When the glue dries, the lice entrapped in it become fully immobilized. Immobilization of lice for a period of time will cause the lice to die. The medication is applied to the hair and scalp of a human containing head lice to effectively kill the head lice without having any known harmful effects on the human. Both the glue and de-licing insecticide are water soluble to facilitate removal of the medication from the hair and scalp. The treatment for head lice includes application of the glue and de-licing insecticide, without necessarily being in combination with the other, to the hair and scalp to kill the lice.

### BACKGROUND OF THE INVENTION

The present invention relates to a medication and method treatment for removing head lice. The medication is applied to the hair and scalp of a human containing head lice which effectively kills the head lice, and obstructs hatching of head lice eggs without any known harmful side effect.

Lice are parasites which, when introduced into the hair of a human, move to the scalp where they become resident and feed on the blood of the human. Lice may pierce the skin and exude an antigenic salivary secretion which, with the piercing of the skin, creates a pruritic dermatitis (“Parasitic Infestations, Stings, and Bites”, p. 512).

Additionally, the lice in the scalp lay eggs. The eggs become attached to hairs close to the scalp by a drop of cement secreted by the female louse, which subsequently becomes hard (“Treatment of Pediculosis: New Approaches to Combating Resistant Head Lice”, Power-Pak C.E., 2001, p. 1 to 2). Upon sufficient growth, the eggs hatch thereby increasing the numbers of lice in the scalp. It has been suggested that human blood facilitates growth of the lice (Id., p. 2).

If not treated, the amount of lice in the hair and scalp may become substantial and thereby pose a serious health risk. One health risk of lice is that they may transmit an infectious disease such as epidemic typhus, relapsing fever, or trench fever (“Parasitic Infestations, Stings, and Bites”, p. 512).

Once a significant number of lice get a foothold in the scalp of a human, they are extremely difficult to eradicate. It has been reported (Gorlick, “Stronger Breed of Head Lice Survives”, Associated Press, Oct. 28, 2002) that 12 million school children suffer from head lice annually. As a result, various attempts have been made to treat people who have head lice. These include shampoos and other anti-lice substances.

Developing an effective treatment for head lice has encountered several difficulties. For example, a fundamental requirement for any anti-lice substance which is applied to the scalp of a human is that it kill the lice yet do little or no harm to the human host. Such “selective” toxicity has proven to be difficult to achieve. Many pesticides known to be extremely toxic to certain insects and the like have, unfortunately, been found to be extremely harmful to humans, such as DDT.

Additionally, it has been reported that lice, which are exposed to an insecticide which initially causes severe harm or death to the lice, may develop a resistance or genetic immunity to the insecticide (Gorlick). Accordingly, over time, the insecticide may become ineffective against the lice. Reportedly, in the U.K., head lice have become “extremely” resistant to malathion, and the pyrethroids (“Treatment-Resistant Head Lice Rule Britannia”, Skin & Allergy News, Oct. 15, 2002, Vol. 33, No. 11). Additionally, in the U.K., resistance by head lice to carbaryl has been reported (Id.). One doctor in the U.K. reportedly observed that only “megadoses of pyrethroids-doses sufficient to kill the host-begin to show efficacy against head lice” (Id.).

Currently available medications for lice include 1-Permethrin, 2-Pyrethrum, 3-Malathion, 4-Lindane (Gamma Benzene) 5-DDT, and 6-Crotamiton. These medications are no longer effective in killing lice in the US and Europe. This is because the lice have become resistant to these chemicals. Higher concentrations of these compounds may kill the lice but it could be toxic for the human which carries the lice.

It is known that immobilization of lice for a certain period of time causes the lice to die. In the past, Vaseline (trademark), mayonnaise, and thick yogurt have been used to smother the lice, and prevent their movement and sucking of blood, which is necessary for their survival.

One reported attempt (Gorlick) to impede the development by the lice of resistance or genetic immunity to an insecticide is to vary the active ingredient(s) in the anti-lice substance to reduce the number of exposures of the lice to a specific version of the substance. However, this may increase the complexity of the production and use of the insecticide because various formulations of the insecticide will be required to be produced and used.

### SUMMARY OF THE INVENTION

The present invention includes a medication which, when applied to the hair and scalp of a human containing lice, kills lice and obstructs hatching of the concomitant lice eggs.

The medication contains a water soluble glue and an de-licing insecticide, such as d-Limonene or highly concentrated lemon juice. Glue is effective against lice because application of the glue, in a soft or liquid state, to the hair and scalp results in the lice becoming entrapped in the glue. When the glue stiffens, the lice entrapped in it become fully immobilized. Immobilization of lice for a period of time will cause the lice to die, principally by preventing access of the lice to blood in the scalp. An additional contributing factor in the death of lice eggs by their entrapment in the dried glue is that the hatching of the eggs is obstructed by the glue.

Water soluble glue has numerous advantages as a treatment for lice. For example, such glue facilitates easy and safe removal of the glue from the hair and scalp after thorough application of the glue thereto. Also, while glue kills head lice, glue is not known to have harmful effects on humans when applied to the hair and scalp.

Additionally, the mechanism by which the glue attacks the lice is mechanical in that the glue prevents physical movement of the lice. In contrast, the attack by insecticides on lice is typically of a biochemical nature. Accordingly, the evolutionary mechanism by which lice may develop resistance to such insecticides from repeated exposure would not appear to directly relate to the development of a resistance to an attack which is mechanical in nature. Accordingly, the lice would not necessarily be expected to develop a resistance corresponding to their reported development of resistance to biochemical insecticides.

d-Limonene is an extract from orange peels. d-Limonene is an effective insecticide that is not known to be harmful to humans. A product, “Orange Guard” (trade name), which contains d-Limonene has reportedly been classified as foodgrade by the FDA (www.orangeguard.com, “technical info”).

d-Limonene has numerous advantages as a treatment for lice. For example, d-Limonene is water soluble. This facilitates easy and safe removal of the d-Limonene from the hair and scalp after thorough application of the d-Limonene thereto. Also, while d-Limonene kills head lice, d-Limonene is not known to have harmful effects on humans when applied to the hair and scalp.

d-Limonene may be expected to kill lice and eggs since the lethality to lice of d-Limonene does not appear to be related to the immobilization of the lice. Thus, eggs, which may be immobile even when healthy, may nevertheless be vulnerable to d-Limonene.

The combination of glue and a de-licing insecticide, such as d-Limonene or highly concentrated lemon juice, in the medication is effective because it has the advantages of both the glue and the insecticide. Additionally, the medication has advantages which result from the combination. For example, the lice which are in contact with the scalp when the glue is applied may be coated with the glue yet remain in contact with the scalp allowing such lice to continue to access the blood in the scalp. Therefore, such lice may not die as a result of the mechanism provided by glue alone for causing the lice to die. However, such lice will die by the inclusion in the medication of the insecticide since the lice will be in contact with the insecticide since it is mixed with the glue. Moreover, the effectiveness of the insecticide is increased by it being in combination with the glue because the glue, upon drying, holds the lice in contact with the insecticide. This increases the duration of the exposure of the lice, including eggs, to the insecticide which is toxic to lice.

The present invention also provides a treatment in which glue, d-Limonene, or highly concentrated lemon juice, without necessarily being in combination with the other, are applied to the hair and scalp for the treatment thereof. These substances have heretofore not been used to treat hair and scalp for lice.

These and other features and advantages of the invention will be more fully understood from the following description of specific embodiments of the invention taken together with the accompanying drawings.

### DETAILED DESCRIPTION

The present invention provides for a medication which, when applied to the hair and scalp of a human head containing lice, kills the lice. Also, the present invention provides for a treatment in which glue, d-Limonene or highly concentrated lemon juice, without necessarily being in combination with the other, are applied to the hair and scalp as a treatment for lice.

The medication and treatment of the present invention may be effectively applied to both the hair and scalp, or to one and not the other. The latter scenario may be illustrated by applying the anti-lice substance to the hair of a head without extending the application sufficiently to reach the scalp. Alternatively, the latter scenario may be illustrated by applying the anti-lice substance to the scalp of a person with no hair. Accordingly, reference herein to the “hair or scalp” shall be interpreted as referring to the conjunctive and alternative, i.e., understood to include “hair and scalp” or “hair or scalp”.

One embodiment of the medication includes glue and a de-licing insecticide in combination. The glue is water soluble and non-toxic to humans. The solvent is water. Preferably, the glue, after application to the hair or scalp and after drying, is clear and flexible. This results in the glue, when on the hair or scalp after such application thereto, not significantly affecting the visual appearance of the hair or scalp. Also, the glue may withstand, without breaking, touching or significant mechanical force or pressure. An example of glue which has been found to be effective for the treatment of the present invention is a thixotropic adhesive gel. Examples of such thixotropic adhesive gels are disclosed in U.S. Pat. No. 5,284,897 (Feb. 8, 1994) and U.S. Pat. No. 5,473,005 (Dec. 5, 1995), the entire disclosures of which are each hereby incorporated by reference herein.

Various formulations of such thixotropic adhesive gels are possible, such as

I. A clear thixotropic adhesive gel consisting essentially of:

A. about 70% to 93% of water;

B. about 5% to 25% of partially hydrolyzed polyvinyl alcohol;

C. about 0.5% to 1.5% of a thickening agent polymer compatible with the polyvinyl alcohol selected from the group consisting of sodium carboxymethylcellulose, sodium alginate, and xanthan gum;

D. about 0.5% to 3% of a water-soluble plasticizer for the polyvinyl alcohol; and

E. about 0.05% to 0.35% of a water-soluble defoamer.

II. A clear thixotropic adhesive gel consisting essentially of, by weight:

A. about 70% to 93% of water;

B. about 5% to 25% of partially hydrolyzed polyvinyl alcohol;

C. about 0.5% to 3% of a water soluble plasticizer for the polyvinyl alcohol;

D. a water soluble defoamer in an amount sufficient to prevent air bubbles from destroying the clarity of the gel; and

E. about 0.5% to 1.5% of a water soluble thickening agent polymer compatible with the polyvinyl alcohol to impart a thixotropic index to the gel of about 1.5 to 4.5, said thickening agent selected from the group consisting of sodium carboxymethylcellulose, sodium alginate and xanthan gum.

III. A thixotropic adhesive gel comprising, by weight:

A. about 70% to 93% water;

B. about 5% to 25% of partially hydrolyzed polyvinyl alcohol;

C. about 0.1% to 1.5% of xanthan gum;

D. a triphenyl methane dye in an amount sufficient to impart color to the composition, and

E. a water-soluble plasticizer in an amount sufficient to plasticize the polyvinyl alcohol.

IV. A clear thixotropic adhesive gel consisting essentially of, by weight:

A. about 75% to 93% water;

B. about 5% to 20% of partially hydrolyzed polyvinyl alcohol;

C. a water-soluble plasticizer in an amount sufficient to plasticize the polyvinyl alcohol;

D. a defoamer in an amount sufficient to prevent air bubbles from destroying the clarity of the gel; and

E. about 0.2% to 0.8% of xanthan gum.

V. A clear thixotropic adhesive gel consisting essentially of, by weight:

A. about 70% to 93% water;

B. about 5% to 25% of partially hydrolyzed polyvinyl alcohol;

C. about 0.5% to 3% of a water-soluble plasticizer for the polyvinyl alcohol;

D. a water soluble defoamer in an amount sufficient to prevent air bubbles from destroying the clarity of the gel; and

E. about 0.1% to 1.5% of xanthan gum.

Other examples of water soluble glue which may be used in the medication include most of the known glues for paper which are safe, non-toxic to humans, and water washable. A further possible embodiment for the glue is white in color, sold under the trademark “Elmer's”, and possible embodiment for the glue is white in color, sold under the trademark “Elmer's”, and typically used for paper. Another possible embodiment for the glue is yellowish in color and typically sold in a glass bottle. Alternative embodiments of the glue include Katira which is imported from Iran, and latex extracted from the trunk of trees such as apricot, pear, prune, and peach trees. Additional embodiments of the glue include glues from other natural sources such as other plants and vegetables.

One embodiment of the de-licing insecticide is d-Limonene which is an effective insecticide without having any known harmful effects on humans. d-Limonene is reportedly (www.orangeguard.com) water-based and is a steam-distilled byproduct of citrus peels, entirely of natural origin. Evidence of the effectiveness of orange peel as a natural insect repellant has been reported to be that intrusions of the peels from insect bites are never found. A commercially available product containing d-Limonene is marketed by Orange Guard Inc., 7 Tampa Canyon Road, Carmel Valley, Calif. 93924. The product contains 5.8% d-Limonene )orange peel extract) and 94.2% inert ingredients. The product is EPA registered, EPA Est. No. 061887-CA-001 61887-1-A.

Following is reported information (www.orangeguard.com) regarding the product:

Identification

Trade Name: Orange Guard

Cas Registry #: 5989-5 (d-Limonene)

Cas Registry Names: Citrus Terpenes, Orange Terpenes, Menthadiene

The active ingredient is d-Limonene (solvent). This is a steam-distilled byproduct of citrus peels, entirely of natural origin.

Orange Guard is waterbased and all ingredients are classified foodgrade by the FDA.

Physical & Chemical Characteristics

| | |
|---|---|
| Boiling Point: | 99-100 degrees C. |
| Vapor Pressure: | 0.82 @ 100 degrees F. |
| Vapor Density: | Not volatile |
| Water Solubility: | Readily soluble |
| Melting/Freezing Point: | No data found |
| Appearance: | White, opalescent |
| Specific Gravity: | 0.9753 g/m I |
| Evaporation Rate: | Not volatile |
| PH: | 6.1 |
| Viscosity: | 1.97 centipose @ 100 degrees F. |
| Miscibility: | Completely in all proportions |
| Odor: | Citrus like |

In another embodiment of the medication, the de-licing insecticide may be highly concentrated lemon juice. In still another embodiment of the medication, the de-licing insecticide may be highly concentrated lemon juice in combination with d-Limonene. A further embodiment of the medication is d-Limonene in combination with highly concentrated lemon juice, without necessarily including glue. Additional embodiments may include glues and de-licing insecticides form other sources such as the trees, plants and vegetables identified herein. Additionally, extracts from other such natural sources are possible for both the glue and the de-licing insecticide. Such variable sources and combinations inhibit the lice from developing a resistance to the medication.

In use, the medication, including a water-soluble glue and de-licing insecticide, in a soft or liquid state, is applied to the hair or scalp. The medication is left on the hair or scalp for a sufficient period of time for the glue in the medication to become stiff and thereby immobilize lice which may be present in the hair or scalp. Provision is made for the medication to remain on the hair or scalp for a period of time sufficient to cause the immobilized lice to die.

Water is then applied to the medication to cause the stiffened glue to soften. The medication and dead lice are removed from the hair and scalp, such as by rinsing.

The treatment of the present invention provides for the application of glue, without necessarily being in combination with a de-licing insecticide, to the hair or scalp. The treatment provides for allowing the glue to remain on the hair or scalp for a period of time sufficient to cause the glue to stiffen and thereby immobilize the lice. The glue is allowed to continue to remain on the hair or scalp for a period of time sufficient to cause the immobilized lice to die. The treatment provides for application of water to the stiffened glue to cause the glue to soften. The softened glue, water, and dead lice are then rinsed from the hair or scalp. Lice which are attached to the scalp and able to suck blood therefrom may be able to survive an initial application of the glue to the hair or scalp. However, repeated such applications of the glue will result in essentially all of the lice being killed.

Also, the treatment of the present invention provides for the application of d-Limonene, without necessarily being in combination with glue or highly concentrated lemon juice, to the hair or scalp. The treatment provides for allowing the d-Limonene to remain on the hair or scalp for a period of time sufficient to cause the lice to die. The d-Limonene and dead lice are then removed from the hair or scalp, such as by rinsing with water.

Additionally, the treatment of the present invention provides for the application of highly concentrated lemon juice, without necessarily being in combination with glue or d-Limonene, to the hair or scalp. The treatment provides for allowing the highly concentrated lemon juice to remain on the hair or scalp for a period of time sufficient to cause the lice to die. The highly concentrated lemon juice and dead lice are then removed from the hair or scalp, such as by rinsing with water.

While the invention has been described by reference to certain preferred embodiments, it should be understood that numerous changes could be made within the spirit and scope of the inventive concept described. Accordingly, it is intended that the invention not be limited to the disclosed embodiments, but that it have the full scope permitted by the language of the following claims.

What is claimed is:

1. A medication for treating head lice comprising:
a water-soluble glue; and
a de-licing insecticide.

2. A medication according to claim 1 wherein said glue comprises a thixotropic adhesive gel.

3. A medication according to claim 2 wherein said thixotropic adhesive gel is clear and consists essentially of:
A. about 70% to 93% of water;
B. about 5% to 25% of partially hydrolyzed polyvinyl alcohol;
C. about 0.5% to 1.5% of a thickening agent polymer compatible with the polyvinyl alcohol selected from the group consisting of sodium carboxymethyleellulose, sodium alginate, and xanthan gum;
D. about 0.5% to 3% of a water-soluble plasticizer for the polyvinyl alcohol; and
E. about 0.05% to 0.35% of a water-soluble defoamer.

4. A method according to claim 2 wherein said thixotropic adhesive gel is clear and consists essentially of, by weight:
A. about 70% to 93% of water;
B. about 5% to 25% of partially hydrolyzed polyvinyl alcohol;
C. about 0.5% to 3% of a water soluble plasticizer for the polyvinyl alcohol;
D. a water soluble defoamer in an amount sufficient to prevent air bubbles from destroying the clarity of the gel; and
E. about 0.5% to 1.5% of a water soluble thickening agent polymer compatible with the polyvinyl alcohol to impart a thixotropic index to the gel of about 1.5 to 4.5, said thickening agent selected from the group consisting of sodium carboxymethylcellulose, sodium alginate and xanthan gum.

5. A medication according to claim 2 wherein said thixotropic adhesive gel comprises, by weight:
A. about 70% to 93% water;
B. about 5% to 25% of partially hydrolyzed polyvinyl alcohol;
C. about 0.1% to 1.5% of xanthan gum;
D. a triphenyl methane dye in an amount sufficient to impart color to the composition; and
E. a water-soluble plasticizer in an amount sufficient to plasticize the polyvinyl alcohol.

6. A medication according to claim 2 wherein said thixotropic adhesive gel is clear and consists essentially of, by weight:
A. about 75% to 93% water;
B. about 5% to 20% of partially hydrolyzed polyvinyl alcohol;
C. a water-soluble plasticizer in an amount sufficient to plasticize the polyvinyl alcohol;
D. a defoamer in an amount sufficient to prevent air bubbles from destroying the clarity of the gel; and
F. about 0.2% to 0.8% of xanthan gum.

7. A medication according to claim 2 wherein the thixotropic adhesive gel is clear and consists essentially of, by weight:
A. about 70% to 93% water;
B. about 5% to 25% of partially hydrolyzed polyvinyl alcohol;
C. about 0.5% to 3% of a water-soluble plasticizer for the polyvinyl alcohol;
D. a water soluble defoamer in an amount sufficient to prevent air bubbles from destroying the clarity of the gel; and
E. about 0.1% to 1.5% of xanthan gum.

8. A medication according to claim 1 wherein said de-licing insecticide comprises d-Limonene.

9. A medication according to claim 1 wherein said de-licing insecticide comprises highly concentrated lemon juice.

10. A medication according to claim 1 wherein said de-licing insecticide comprises:
d-Limoene; and
highly concentrated lemon juice.

11. A medication for treating head lice comprising:
d-Limonene; and
highly concentrated lemon juice.

12. A method for treating head lice comprising:
applying a soft water-soluble glue to the hair or scalp of a human head;
providing for the glue to remain on the hair or scalp for a period of time sufficient to cause the glue to stiffen and thereby immobilize lice which may be present in the hair or scalp;
providing for the glue to continue to remain on the hair or scalp for a period of time sufficient to cause the immobilized lice to die;
applying water to the stiffened glue to cause the glue to soften; and
rinsing the softened glue and dead lice from the hair or scalp.

13. A method according to claim 12 wherein the glue comprises a thixotropic adhesive gel.

14. A method according to claim 13 wherein the thixotropic adhesive gel is clear and consists essentially of:
A. about 70% to 93% of water;
B. about 5% to 25% of partially hydrolyzed polyvinyl alcohol;
C. about 0.5% to 1.5% of a thickening agent polymer compatible with the polyvinyl alcohol selected from the group consisting of sodium carboxymethylcellulose, sodium alginate, and xanthan gum;
D. about 0.5% to 3% of a water-soluble plasticizer for the polyvinyl alcohol; and
E. about 0.05% to 0.35% of a water-soluble defoamer.

15. A method according to claim 13 wherein the thixotropic adhesive gel is clear and consists essentially of, by weight:
A. about 70% to 93% of water;
B. about 5% to 25% of partially hydrolyzed polyvinyl alcohol;
C. about 0.5% to 3% of a water soluble plasticizer for the polyvinyl alcohol;
D. a water soluble defoamer in an amount sufficient to prevent air bubbles from destroying the clarity of the gel; and
E. about 0.5% to 1.5% of a water soluble thickening agent polymer compatible with the polyvinyl alcohol to impart a thixotropic index to the gel of about 1.5 to 4.5, said thickening agent selected from the group consisting of sodium carboxymethylcellulose, sodium alginate and xanthan gum.

16. A method according to claim 13 wherein the thixotropic adhesive gel comprises, by weight:
A. about 70% to 93% water;
B. about 5% to 25% of partially hydrolyzed polyvinyl alcohol;
C. about 0.1% to 1.5% of xanthan gum;
D. a triphenyl methane dye in an amount sufficient to impart color to the composition; and
E. a water-soluble plasticizer in an amount sufficient to plasticize the polyvinyl alcohol.

17. A method according to claim 13 wherein the thixotropic adhesive gel is clear and consists essentially of, by weight:
A. about 75% to 93% water;
B. about 5% to 20% of partially hydrolyzed polyvinyl alcohol;
C. a water-soluble plasticizer in an amount sufficient to plasticize the polyvinyl alcohol;
D. a defoamer in an amount sufficient to prevent air bubbles from destroying the clarity of the gel; and
E. about 0.2% to 0.8% of xanthan gum.

18. A method according to claim 13 wherein the thixotropic adhesive gel is clear and consists essentially of, by weight:
A. about 70% to 93% water;
B. about 5% to 25% of partially hydrolyzed polyvinyl alcohol;
C. about 0.5% to 3% of a water-soluble plasticizer for the polyvinyl alcohol;
D. a water soluble defoamer in an amount sufficient to prevent air bubbles from destroying the clarity of the gel; and
E. about 0.1% to 1.5% of xanthan gum.

19. A method according to claim 12 wherein the step of applying the glue comprises applying the glue to the hair and scalp, the steps of providing for the glue to remain on the hair or scalp comprising providing for the glue to remain on the hair and scalp for a period of time sufficient to cause the glue to stiffen and thereby immobilize lice which may be present in the hair or scalp, and providing for the glue to continue to remain on the hair and scalp for a period of time sufficient to cause the immobilized lice to die, the step of rinsing comprising rinsing the softened glue and dead lice from the hair and scalp.

20. A method for treating head lice comprising:
applying d-Limonene to the hair or scalp of a human head;
providing for the d-Limonene to remain on the hair or scalp for a period of time sufficient to cause lice which may be present in the hair or scalp to die; and
removing the d-Limonene and dead lice from the hair or scalp.

21. A method according to claim 20 wherein the step of removing the d-Limonene and dead lice comprises rinsing with water the d-Limonene and dead lice from the hair or scalp.

22. A method according to claim 20 wherein
the step of applying the d-Limonene comprises applying the d-Limonene to the hair and scalp,
the step of providing for the d-Limonene to remain on the hair or scalp comprising providing for the d-Limonene to remain on the hair and scalp for a period of time sufficient to cause lice which may be present in the hair and scalp to die,
the step of removing comprising removing the d-Limonene and dead lice from the hair and scalp.

23. A method for treating head lice comprising:
applying highly concentrated lemon juice to the hair or scalp of a human head;
providing for the highly concentrated lemon juice to remain on the hair or scalp for a period of time sufficient to cause lice which may be present in the hair or scalp to die; and
removing the highly concentrated lemon juice and dead lice from the hair or scalp.

24. A method according to claim 23 wherein the step of removing the highly concentrated lemon juice and dead lice comprises rinsing with water the highly concentrated lemon juice and dead lice from the hair or scalp.

25. A method according to claim 23 wherein
the step of applying the highly concentrated lemon juice comprises applying the highly concentrated lemon juice to the hair and scalp,
the step of providing for the highly concentrated lemon juice to remain on the hair or scalp comprising providing for the highly concentrated lemon juice to remain on the hair and scalp for a period of time sufficient to cause lice which may be present in the hair and scalp to die,
the step of removing comprising removing the highly concentrated lemon juice and dead lice from the hair and scalp.
